(19) United States
(12) Patent Application Publication
(10) Pub. No.: US 2026/0023226 A1
(43) Pub. Date: Jan. 22, 2026

(54) HEAT DISSIPATION STRUCTURE OF OPTICAL MODULE

(71) Applicant: InnoLight Technology (Suzhou) Ltd., Suzhou, Jiangsu (CN)

(72) Inventors: Dongjian Chen, Suzhou, Jiangsu (CN); Hao SHU, Suzhou, Jiangsu (CN); Changwu Lu, Suzhou, Jiangsu (CN)

(21) Appl. No.: 18/998,066

(22) PCT Filed: Jun. 16, 2023
(86) PCT No.: PCT/CN2023/100651

§ 371 Date: Jan. 23, 2025

(30) Foreign Application Priority Data
Aug. 23, 2022 (CN) 202222223948.6

(51) Int. Cl. G02B 6/42

(52) U.S. Cl. CPC G02B 6/4269; G02B 6/4272

(57) ABSTRACT

A heat dissipation structure of an optical module. A heat dissipation layer (200) is arranged on a bottom plate (110) of a base (100). Pressing parts (121) are arranged on two sides in the width direction of the bottom plate (110). A heat dissipation module (300) is used to press down to apply an acting force to the heat dissipation layer (200), such that a first plate body (310) of the heat dissipation module (300) presses the heat dissipation layer (200) to deform. The pressing parts (121) are closely fitted to the first plate body (310) by using the springback property of the heat dissipation layer (200). The pressing parts (121) tightly press a limiting part (3101) of the first plate body (310) to prevent the heat dissipation module (300) from moving in an accommodation cavity (130), thereby ensuring the assembly stability. The heat dissipation layer (200) can absorb flatness and deformation degree tolerances of the first plate body (310) and the bottom plate (110), such that interface thermal resistance can be reduced, thereby ensuring the heat dissipation performance. In addition, due to springback of the heat dissipation layer (200), the first plate body (310) is closely fitted to the pressing parts (121), such that the strength of connection between the heat dissipation module (300) and the base (100) is further enhanced.

### CROSS-REFERENCE TO RELATED PATENT APPLICATION

The present disclosure claims priority to the Chinese patent application filed with the China Patent Office on Aug. 23, 2022, with application Ser. No. 20/222,2223948.6 and the invention name “HEAT DISSIPATION STRUCTURE OF OPTICAL MODULE”, the entire content of which is incorporated into the present disclosure by reference.

### FIELD OF THE DISCLOSURE

The present disclosure relates to the technical field of optical modules, and specifically to a heat dissipation structure of an optical module.

### BACKGROUND TECHNIQUE

With the rapid development of communication technology and the growing demand for cloud computing, the market demand for high-speed optical modules is increasing significantly. Optical modules must operate within their defined temperature range; if the operating temperature is too high, device aging accelerates, adversely affecting the performance of the optical module. Consequently, the heat dissipation structure of the optical module is particularly critical. During operation, the heat generated by the optical module is primarily dissipated through heat dissipation fins. However, when the connection strength between the heat dissipation fins and the base is insufficient, the fins can easily detach from the base under vibration or shock. Therefore, the connection strength between the heat dissipation fins and the base shell plays a vital role in determining the heat dissipation performance of the optical module.

### SUMMARY OF THE DISCLOSURE

The present disclosure provides a heat dissipation structure of an optical module to solve the technical problem that the heat dissipation fins are easily separated from the base and affect the heat dissipation performance.

The present application provides a heat dissipation structure of an optical module including: a base, wherein the base includes a bottom plate and pressing parts provided on both sides of the bottom plate in a width direction, and the pressing parts protrude from the surface of the bottom plate; a heat dissipation layer provided on the bottom plate along a length direction of the bottom plate; and a heat dissipation module including a first plate body, a fin provided on the first plate, and a limiting part located on both sides of the first plate, wherein the heat dissipation module (300) is installed on the bottom plate and stacked on the heat dissipation layer; wherein, the pressing part cooperates with the limiting part to fix the heat dissipation module on the bottom plate, the heat dissipation module is pressed down, the first plate presses the heat dissipation layer, and the heat dissipation layer is tightly fitted between the first plate and the bottom plate.

Optionally, the base further includes two limiting plates formed on both sides of the bottom plate, and the pressing part is formed on the two limiting plates and protrudes toward a space between the two limiting plates.

Optionally, the limiting part is formed by a portion of the first plate extending from the fin, and the first plate is provided with an escape groove for the pressing part to pass through.

Optionally, the heat dissipation module includes a second plate arranged opposite to the first plate, and the fin is provided between the first plate and the second plate.

Optionally, an electrical port end and an optical port end (are further comprised, the electrical port end is arranged at one end in a length of the bottom plate, and the optical port end is arranged at another end in a length direction of the bottom plate; and a distance between the bottom surface of the pressing part and the bottom plate adjacent to the bottom plate gradually reduces along an assembly direction of the heat dissipation module relative to the bottom plate; wherein when the heat dissipation module is assembled along a length direction of the bottom plate, the pressing part gradually presses against the limiting part to fix the heat dissipation module on the bottom plate.

Optionally, a first stop step is further included, and the first stop step is protrudingly provided on the bottom plate adjacent to the optical port end or the electrical port end, wherein the first stop step is arranged along a width direction of the bottom plate; the heat dissipation module moves along a length direction of the bottom plate toward the optical port end or the electrical port end, and the first stop step resists the first plate to form a stop for a movement of the heat dissipation module in a direction adjacent to the optical port end or the electrical port end.

Optionally, a second stop step is further included, and the second stope step is protrudingly provided between the bottom plate and a side opposite to the first stop step, and the second stop step is arranged along a width direction of the bottom plate; the second stop step forms a stop for a movement of the heat dissipation module along a length direction of the bottom plate; and a protruding height of the second stop step relative to the bottom plate is less than a protruding height of the first stop step relative to the bottom plate, and an assembly direction of the heat dissipation module along the bottom plate is from the second stop step to the first stop step.

Optionally, at least two pressing parts are protrudingly provided on the opposite surfaces of the two limiting plates, and at least two pressing parts located on the same limiting plate are arranged at intervals along a length direction of the limiting plate; and the pressing parts on the two limiting plates are arranged at the same height.

Optionally, two pressing parts are protrudingly provided on each of the two limiting plates, one of the two pressing parts is arranged at one end of the limiting plate in a longitudinal direction adjacent to the electrical port end, and another of the two pressing parts is arranged at another end of the limiting plate in a longitudinal direction adjacent to the optical port end.

Optionally, the heat dissipation layer is a heat dissipation glue or heat dissipation glue disposed between the bottom plate and the first plate.

The present application provides a heat dissipation structure for an optical module. A heat dissipation layer is disposed on the bottom plate of the base, with pressing parts provided on both sides of the bottom plate in the width direction. The heat dissipation module is pressed downward to apply force to the heat dissipation layer, causing the third plate body of the heat dissipation module to deform upon compressing the heat dissipation layer. The elasticity of the heat dissipation layer ensures that the pressing parts closely fit the first plate. Additionally, the pressing parts press against the limiting portions of the first plate, preventing the heat dissipation module from moving inward into the accommodation cavity, thereby ensuring assembly stability. The heat dissipation layer absorbs flatness and deformation tolerances between the first plate and the bottom plate, effectively reducing interface thermal resistance and ensuring optimal heat dissipation performance. In addition, due to the rebound of the heat dissipation layer, the first plate and the pressing parts are tightly fitted, further enhancing the connection strength between the heat dissipation module and the base.

Since the heat dissipation layer possesses resilience, applying pressure to deform the heat dissipation layer allows the heat dissipation module to detach from the bottom plate, enabling the reuse of the heat dissipation module and improving its utilization rate. Additionally, as the heat dissipation module is securely fixed to the base through the heat dissipation layer, the assembly of the heat dissipation module and the base can be performed either during the individual component assembly stage or the module assembly stage. This flexibility facilitates the implementation of various process scenarios.

### BRIEF DESCRIPTION OF THE DRAWINGS

In order to more clearly illustrate the technical solutions in the embodiments of the present application, the drawings needed to be used in the description of the embodiments will be briefly introduced below. Obviously, the drawings in the following description are only some embodiments of the present application. For those skilled in the art, other drawings can also be obtained based on these drawings without exerting creative efforts.

FIG. 1 is a schematic structural diagram of the heat dissipation structure of the optical module provided by the present disclosure;

FIG. 2 is an exploded schematic diagram of the heat dissipation structure of the optical module provided by the present disclosure;

FIG. 3 is a schematic structural diagram of the base in the heat dissipation structure of the optical module provided by the present disclosure; and

FIG. 4 is a schematic structural diagram of the heat dissipation module in the heat dissipation structure of the optical module provided by the present disclosure.

### EXPLANATION OF REFERENCE NUMERALS

100. Base, 110. Bottom plate, 120. Limiting plate, 121. Pressing part, 130. Accommodation cavity, 140. Electrical port end, 150. Optical port end, 161. First stop step, 162. Second stop step, 200, heat dissipation layer, 300, Heat dissipation module, 310, First plate, 3101, Limiting part, 311, Avoidance groove, 320, Second plate, 330, Fins, 331, Heat dissipation channel, 331a, First port, 331b, Second port.

### DETAILED DESCRIPTION OF THE EXEMPLARY EMBODIMENTS

The technical solutions in the embodiments of the present application will be clearly and completely described below with reference to the accompanying drawings in the embodiments of the present application. Obviously, the described embodiments are only some of the embodiments of the present application, rather than all of the embodiments. Based on the embodiments in the present disclosure, all other embodiments obtained by those skilled in the art without making creative efforts fall within the scope of protection of the present disclosure. In addition, it should be understood that the specific embodiments described here are only used to illustrate and explain the application, and are not used to limit the application. In the present disclosure, unless otherwise stated, the directional words used such as “upper”, “lower”, “left” and “right” usually refer to the upper, lower and left positions of the device in actual use or working state and right, specifically the drawing direction in the attached drawing.

The present disclosure provides a heat dissipation structure of an optical module, which will be described in detail below. It should be noted that the description order of the following embodiments does not limit the preferred order of the embodiments of the present application. In the following embodiments, each embodiment is described with its own emphasis. For parts that are not described in detail in a certain embodiment, please refer to the relevant descriptions of other embodiments.

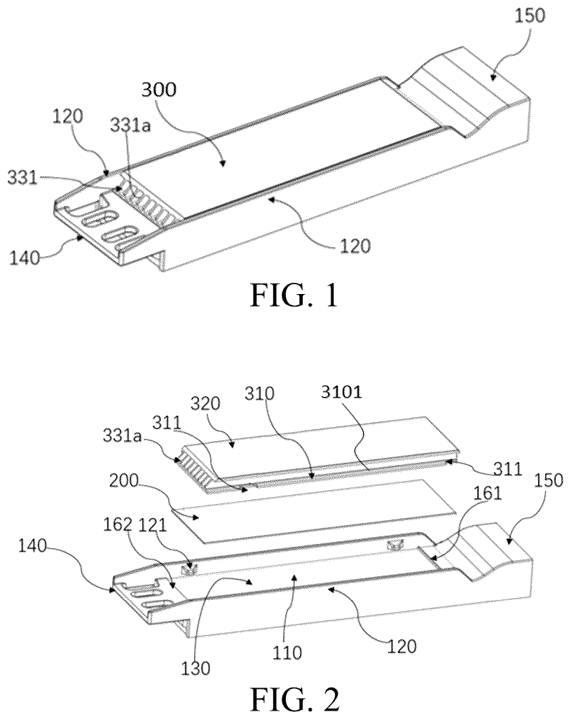

Please refer to FIGS. 1 to 4. The present disclosure provides a heat dissipation structure of an optical module, which includes a base 100, a heat dissipation layer 200 and a heat dissipation module 300.

The base 100 is a component of the optical module housing, designed to accommodate optical devices, circuit boards, and other components. The base 100 comprises a bottom plate 110 and two limiting plates 120. The length direction of the bottom plate 110 is denoted as X, and the width direction as Y. The two limiting plates 120 are positioned on either side of the bottom plate 110 along the width direction Y. Together, the two limiting plates 120 and the bottom plate 110 define a accommodation cavity 130. Two pressing parts 121 are protrudingly disposed on the opposite surfaces of the two limiting plates 120, extending toward the space between the two limiting plates 120. On each limiting plate 120, the two pressing parts 121 are spaced at intervals along the length direction X, and the pressing parts 121 on the two limiting plates 120 correspond to each other and are set at the same height. The same height setting means that the distances between the pressing parts 121 and the surface of the bottom plate 110 are the same, and they are all located at the same height. Each pressing part 121 has a frustum shape and protrudes from the surface of the limiting plates 120 along the width direction Y of the bottom plate 110.

Additionally, the base 100 includes an electrical port end 140 and an optical port end 150. The electrical port end 140 is located at one end of the bottom plate 110 in the length direction X, while the optical port end 150 is positioned at the opposite end of the bottom plate 110 in the length direction X. One end of each limiting plate 120 in the length direction extends toward the electrical port end 140, while the other end extends toward the optical port end 150. The direction from the electrical port end 140 to the optical port end 150 is defined as the installation direction, which is parallel to the length direction X of the bottom plate 110.

The heat dissipation layer 200 is installed within the accommodation cavity 130 and is disposed on the surface of the bottom plate 110 along the length direction. The heat dissipation layer 200 is made of a flexible elastic material, so that the heat dissipation layer 200 has the properties of resilience and high thermal conductivity. The heat dissipation layer 200 may be composed of heat dissipation glue or a heat dissipation pad. The material of the heat dissipation layer 200, as disclosed herein, may include polymer materials, providing properties such as anti-aging, corrosion resistance, and friction resistance. Additionally, the heat dissipation layer 200 can be made of a polymer material with inherent viscosity or enhanced using auxiliary methods, such as applying adhesive to its surface, to ensure a certain degree of adhesion. This improves the tightness of the joint between the heat dissipation layer 200 and the heat dissipation module 300. Furthermore, the heat dissipation layer 200 may be configured as a glue layer possessing resilience, thermal conductivity, anti-aging, corrosion resistance, and friction resistance properties.

Referring to FIGS. 1, 2, and 4, the heat dissipation module 300 includes a first plate 310, a second plate 320, and fins 330. The first plate 310 and the second plate 320 are positioned oppositely, with the fins 330 arranged between them. The fins 330 are aligned along the length direction of the bottom plate 110. The number of fins 330 is multiple, and they are spaced apart at intervals along the width direction of the bottom plate 110. A heat dissipation channel 331 is formed between two adjacent fins 330. The heat dissipation channel 331 has a first port 331a and a second port 331b, which are oppositely positioned along the length direction X of the bottom plate 110.

Referring to FIGS. 2 and 4, the limiting parts 3101 are respectively provided on both sides of the first plate 310, positioned opposite each other along the width direction Y. The limiting parts 3101 are formed by portions of the first plate 310 extending out of the fins 330. Each limiting part 3101 is provided with a relief groove 311 for the pressing part 121 to pass through. The use of multiple heat dissipation channels 331 enhances airflow at the heat dissipation module 300, thereby improving the heat dissipation performance of the optical module. The depth of the relief groove 311 is greater than the length of the pressing part 121. When the heat dissipation module 300 is assembled to the base 100, the orthogonal projection of the pressing part 121 onto the first plate 310 is misaligned with the relief groove 311 and positioned adjacent to it.

In the present disclosure, the heat dissipation layer 200 is first placed on the surface of the bottom plate 110. Subsequently, the relief groove 311 of the first plate 310 is aligned approximately with the pressing part 121, and the heat dissipation module 300 is pressed down towards the heat dissipation layer 200. During this process, the first plate 310 comes into contact with the heat dissipation layer 200 and compresses it, causing the heat dissipation layer 200 to undergo elastic deformation. As the heat dissipation module 300 is pressed down, the pressing part 121 passes correspondingly through the relief groove 311, ensuring that all pressing parts 121 are positioned above the limiting part 3101 of the first plate 310.

Subsequently, the heat dissipation module 300 is moved towards the optical port end 150 along the length direction X of the bottom plate 110 to assemble the heat dissipation module 300 and the base 100, so that the first plate 310 moves relative to the pressing portion 121. When the pressing part 121 is misaligned with the relief groove 311 and the applied pressing force is removed, the heat dissipation layer 200 rebounds due to its resilience. This rebound causes the heat dissipation module 300 to tend to move away from the heat dissipation layer 200 until the first plate 310 comes into contact with the pressing part 121. At this point, the pressing part 121 presses against the limiting part 3101 of the first plate 310, preventing the heat dissipation module 300 from moving further away from the heat dissipation layer 200. This creates a barrier to the movement of the heat dissipation module 300 in the direction perpendicular to the surface of the bottom plate 110. By restricting upward movement, the assembly of the heat dissipation module 300 and the base 100 is completed. Additionally, the first port 331a of the heat dissipation channel 331 faces the electrical port end 140, while the second port 331b faces the optical port end 150.

Referring to FIGS. 2 and 4, when the heat dissipation module 300 is installed on the base 100, the first plate 310 is in close contact with the heat dissipation layer 200, and the second plate 320 is approximately flush with the top of the limiting plate 120. The upper and lower ends of the fins 330 are connected to the second plate 320 and the first plate 310, respectively. This arrangement allows the first plate 310 to transfer heat from the heat dissipation layer 200 to the fins 330. The fins 330 then transfer the heat to the second plate 320 and the heat dissipation channel 331. Subsequently, the second plate 320 and the heat dissipation channel 331 dissipate the heat to the outside of the optical module, thereby rapidly removing heat from the base 100.

The base 100 is a part of the optical module housing, which is designed to accommodate optical devices, circuit boards, and other components. These optical devices, circuit boards, and other components generate a significant amount of heat during operation. Since the heat dissipation layer 200 is directly attached to the bottom plate 110 of the base 100, and the first plate 310 of the heat dissipation module 300 is directly attached to the heat dissipation layer 200, the heat generated by the optical devices, circuit boards, and other components can be efficiently transferred through direct conduction. This arrangement allows the heat to pass through the heat dissipation layer 200 and into the heat dissipation module 300, thereby enhancing the overall heat dissipation efficiency.

In addition, since the heat dissipation layer 200 possesses resilience, it can absorb the flatness and deformation tolerances between the first plate 310 and the bottom plate 110. This characteristic reduces the interface thermal resistance, thereby ensuring optimal heat dissipation performance. Simultaneously, the contact between the first plate 310 and the pressing part 121 further enhances the connection strength between the heat dissipation module 300 and the base 100.

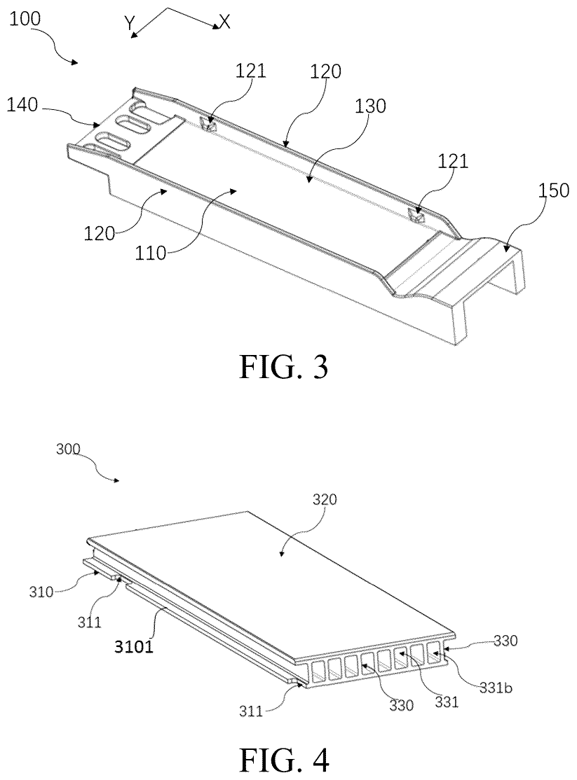

In addition, referring to FIGS. 2 and 3, a first stop step 161 is protrudingly provided on the side of the bottom plate 110 along the length direction X, near the optical port end 150. The first stop step 161 extends along the width direction Y of the bottom plate 110. When the heat dissipation module 300 moves within the accommodation cavity 130 along the length direction X, the first stop step 161 serves as a barrier for the first plate 310, that is, the end surface of the first plate 310 abuts against the first stop step 161, forming a restriction on the movement of the heat dissipation module 300. In alternative implementations, the first stop step 161 may also be positioned on the side of the bottom plate 110 closer to the electrical port end 140 along the length direction X, forming a stop for the heat dissipation module 300 to move along the length direction X of the bottom plate 110 toward the electrical port 140.

In addition, referring to FIGS. 2 and 3, a second stop step 162 is protrudingly provided on the side of the bottom plate 110 along the length direction X, near the electrical port end 140. The second stop step 162 extends along the width direction Y of the bottom plate 110. The protruding height of the second stop step 162 relative to the bottom plate 110 is smaller than that of the first stop step 161 relative to the bottom plate 110. The assembly direction of the heat dissipation module 300 along the bottom plate 110 progresses from the second stop step 162 toward the first stop step 161. The first stop step 161 and the second stop step 162 cooperate to restrict the movement of the heat dissipation module 300 within the accommodation cavity 130 along the length direction X. Additionally, the pressing part 121 applies pressure to the first plate 310, ensuring stable assembly of the heat dissipation module 300 within the accommodation cavity 130 and maintaining effective heat dissipation performance.

In another implementation of this embodiment, the bottom surface of the pressing part 121 is designed as a slope. Specifically, the bottom surface of the pressing part 121 adjacent to the bottom plate 110 gradually decreases in distance from the bottom plate 110 along the assembly direction of the heat dissipation module 300 relative to the bottom plate 110. In this embodiment, the assembly direction of the heat dissipation module 300 relative to the bottom plate 110 is along the length direction X of the bottom plate 110, extending from the electrical port end 140 toward the optical port end 150. When the heat dissipation module 300 moves toward the optical port end 150 along the length direction X for assembly, the pressing portion 121 gradually presses against the limiting portion 3101 of the first plate body 310 to fix the heat dissipation module 300 on the bottom plate 110. This ensures that the heat dissipation module 300 cannot move in a direction perpendicular to the surface of the bottom plate 110 or along the length direction X, thereby maintaining the stability of the assembly.

Referring to FIG. 2, due to the resilience of the heat dissipation layer 200, an interference fit can be achieved between the heat dissipation module 300 and the base 100, effectively fixing the heat dissipation module 300 to the base 100. Moreover, when pressure is applied to the heat dissipation layer 200, causing it to deform, the heat dissipation module 300 can also be separated from the base 100. This feature enables the reuse of the heat dissipation module 300, thereby improving its utilization rate. Furthermore, as the heat dissipation module 300 is relatively fixed to the base 100 through the resilient heat dissipation layer 200, the assembly of the heat dissipation module 300 and the base 100 can be carried out either during the single component stage or the module assembly stage. This flexibility facilitates the implementation of different process scenarios.

In another implementation, the heat dissipation layer 200 may be a metal elastic piece, utilizing its elasticity to achieve relative fixation between the heat dissipation module 300 and the base 100. First, the heat dissipation layer 200 is positioned inside the accommodation cavity 130. During the installation of the heat dissipation module 300 onto the base 100, the heat dissipation layer 200 is compressed, resulting in deformation. Simultaneously, the pressing part 121 passes through the corresponding avoidance groove 311. Subsequently, the heat dissipation module 300 is moved so that the first plate 310 shifts relative to the pressing part 121 until the end of the first plate 310 abuts against the first stop step 161. At this point, the resilience of the heat dissipation layer 200 gradually recovers, ensuring that the heat dissipation module 300 and the base 100 are relatively fixed. Thus, when the heat dissipation layer 200 is implemented as a metal spring, the described installation steps remain applicable.

Referring to FIG. 4, the distance between the first plate 310 and the electrical port end 140 is greater than the distance between the second plate 320 and the electrical port end 140. Additionally, the ends of the fins 330 connected to the first plate 310 are sloped to facilitate adaptation and alignment with other devices on the base 100.

The heat dissipation structure of an optical module provided by the present disclosure has been detailed above. Specific examples are presented in this article to illustrate the principles and implementation methods of the present disclosure. The description of the above embodiments is intended solely to facilitate an understanding of the methods and core ideas of the present disclosure. For those skilled in the art, variations in specific implementation methods and application scope based on the ideas of the present disclosure are expected. In summary, the content of this specification should not be construed as a limitation of the present disclosure.

1. A heat dissipation structure of an optical module, characterized by including:
a base (100), wherein the base (100) includes a bottom plate (110) and pressing parts (121) provided on both sides of the bottom plate (110) in a width direction, and the pressing parts (121) protrude from the surface of the bottom plate (110);
a heat dissipation layer (200) provided on the bottom plate (110) along a length direction of the bottom plate (110); and
a heat dissipation module (300) including a first plate (310), a fin (330) provided on the first plate (310), and a limiting part (3101) located on both sides of the first plate (310), wherein the heat dissipation module (300) is installed on the bottom plate (110) and stacked on the heat dissipation layer (200);
wherein, the pressing part (121) cooperates with the limiting part (3101) to fix the heat dissipation module (300) on the bottom plate (110), the heat dissipation module (300) is pressed down, the first plate (310) presses the heat dissipation layer (200), and the heat dissipation layer (200) is tightly fitted between the first plate (310) and the bottom plate (110).

2. The heat dissipation structure of an optical module according to claim 1, characterized in that the base (100) further includes two limiting plates (120) formed on both sides of the bottom plate (110), and the pressing part (121) is formed on the two limiting plates (120) and protrudes toward a space between the two limiting plates (120).

3. The heat dissipation structure of an optical module according to claim 2, characterized in that the limiting part (3101) is formed by a portion of the first plate (310) extending from the fin (330), and the first plate (310) is provided with an escape groove (311) for the pressing part (121) to pass through.

4. The heat dissipation structure of an optical module according to claim 3, characterized in that the heat dissipation module (300) includes a second plate (320) arranged opposite to the first plate (310), and the fin (330) is provided between the first plate (310) and the second plate (320).

5. The heat dissipation structure of the optical module according to claim 2, further comprising an electrical port end (140) and an optical port end (150), the electrical port end (140) is arranged at one end of the bottom plate (110) in a length direction, and the optical port end (150) is arranged at another end of the bottom plate (110) in a length direction; and
a distance between the bottom surface of the pressing part (121) adjacent to the bottom plate (110) and the bottom plate (110) gradually reduces along an assembly direction of the heat dissipation module (300) relative to the bottom plate (110);
wherein when the heat dissipation module (300) is assembled along a length direction of the bottom plate (110), the pressing part (121) gradually presses against the limiting part (3101) to fix the heat dissipation module (300) on the bottom plate (110).

6. The heat dissipation structure of the optical module according to claim 5, further comprising a first stop step (161) protrudingly provided on the bottom plate (110) adjacent to the optical port end (150) or the electrical port end (140), wherein the first stop step (161) is arranged along a width direction of the bottom plate (110);
the heat dissipation module (300) moving along a length direction of the bottom plate (110) toward the optical port end (150) or the electrical port end (140), and the first stop step (161) resisting the first plate (310) to form a stop for the heat dissipation module (300) to move toward the the optical port end (150) or the electrical port end (140).

7. The heat dissipation structure of the optical module according to claim 5, further comprising a second stop step (162) protrudingly arranged on a side of the bottom plate (110) opposite to the first stop step (161), and the second stop step (162) is arranged along a width direction of the bottom plate (110);
the second stop step (162) forming a stop for a movement of the heat dissipation module (300) along a length direction of the bottom plate (110); and
a protruding height of the second stop step (162) relative to the bottom plate (110) being less than a protruding height of the first stop step (161) relative to the bottom plate (110), and an assembly direction of the heat dissipation module (300) along the bottom plate (110) being from the second stop step (162) to the first stop step (161).

8. The heat dissipation structure of the optical module according to claim 2, characterized in that the opposite surfaces of the two limiting plates (120) are provided with at least two pressing parts (121) respectively, and at least two pressing parts (121) located on the same limiting plate (120) are arranged at intervals along a length direction of the limiting plate (120); and
the pressing parts (121) on the two limiting plates (120) are arranged at the same height.

9. The heat dissipation structure of the optical module according to claim 8, characterized in that two pressing parts (121) are protrudingly provided on each of the two limiting plates (120), one of the two pressing parts (121) is arranged at one end of the limiting plate (120) in a length direction adjacent to the electrical port end (140), and the other of the two pressing parts (121) is arranged at another end of the limiting plate (120) in a length direction adjacent to the optical port end (150).

10. The heat dissipation structure of the optical module according to claim 1, characterized in that the heat dissipation layer (200) is a heat dissipation glue or heat dissipation pad disposed between the bottom plate (110) and the first plate (310).
